(19) United States
(12) Patent Application Publication
(10) Pub. No.: US 2014/0325389 A1
(43) Pub. Date: Oct. 30, 2014

(54) OBJECT SHARING

(71) Applicant: HEWLETT-PACKARD DEVELOPMENT COMPANY, L.P., Fort Collins, CO (US)

(72) Inventors: Christopher Willis, Palo Alto, CA (US); Kevin Smathers, Palo Alto, CA (US)

(73) Assignee: Hewlett-Packard Development Company, L.P., Fort Collins, CO (US)

(21) Appl. No.: 13/871,206

(22) Filed: Apr. 26, 2013

(51) Int. Cl. G06F 3/0486

(52) U.S. Cl. CPC G06F 3/0486
USPC 715/753

(57) ABSTRACT

In one example in accordance with the present disclosure, a system is provided. The system includes a display and a sharing module. The sharing module is to detect that an object is moved and released such that a portion of the released object overlaps at least a portion of a region of the display. The sharing module is then to cause the system to share the object with at least one computing device via a network.

### BACKGROUND

In today's computing environment, computing devices such as personal computers, tablets, and smartphones each include a display to present various objects to a user. For instance, the display may be utilized to present objects such as web pages, media players, applications, files, remote desktop instances, and other content to a user. The user may control and/or relocate these objects on the display via a traditional user interface like a mouse or keyboard, or via an advanced user interface that utilizes, for example, touch input, eye tracking input, speech input, or the like.

### BRIEF DESCRIPTION OF THE DRAWINGS

Examples are described in the following detailed description and in reference to the drawings, in which:

FIG. 1 depicts an example system comprising a display, object, and sharing module in accordance with an implementation;

FIG. 2 depicts an example flow chart of a sharing process in accordance with an implementation;

FIG. 3 depicts an example flow chart of a sharing process that utilizes a shared network folder in accordance with an implementation;

FIG. 4 depicts an example flow chart of a sharing process that determines a destination device and sends the object directly to the destination device in accordance with an implementation;

FIG. 5 depicts an example graphical representation of object transferring in accordance with an implementation; and

FIG. 6 depicts an example electronic device in accordance with an implementation.

### DETAILED DESCRIPTION

The present disclosure is generally directed to sharing objects. More particularly, the present disclosure is generally directed to a novel and previously unforeseen approach for one computing device to share an object with another computing device.

In current computing environments, when a user would like to transfer an object from a first computing device (e.g., a laptop) to a second computing device (e.g., a tablet), the transfer options are somewhat limited. For example, the user may use an application on a first computing device (e.g., an email application) to send the object to an application running on the second computing device (e.g., another email application). Alternatively, the user may copy the object to a portable storage medium (e.g., a flash drive), and upload the content to the second computing device. Still further, the user may communicatively couple the first and second computing devices via a wired/wireless network, and transfer the content over the network.

Regardless of the transfer option utilized, the current transfer processes are quite time-consuming because objects must be copied to the destination computer and then subsequently opened. Moreover, the current transfer processes are not intuitive because they generally require a user to have knowledge of the applications running on the devices, the networks interconnecting the device, and/or the steps for transferring objects between the devices.

Aspects of the present disclosure attempt to address at least these deficiencies by providing an intuitive and rapid approach for sharing objects. In particular, and as described in greater detail below with reference to various examples and figures, aspects of the present disclosure introduce a novel and previously unforeseen sharing approach that enables an object to be shared from a source computing device to a destination computing device by simply moving and releasing the object in a specific region on a display of the source device. More specifically, in one example in accordance with the present disclosure, a system is provided. The system comprises a display and a sharing module. The sharing module is to detect that an object is moved and released such that a portion of the released object overlaps at least a portion of a first region of the display, wherein the first region of the display is proximate to a first edge of the display. The sharing module is then to cause the system to share the object with at least one computing device via a network. Depending on the implementation, the sharing may be conducted by placing the object in a shared network folder and apprising other computing devices that this object is in the folder to retrieve, or, alternatively, determining a destination device for the object and sending the object to the destination device.

In another example in accordance with the present disclosure, a non-transitory machine readable medium is provided. The machine readable medium comprises instructions which, when executed, cause a system to detect that an object is moved and released such that a portion of the released object overlaps a region of a display, wherein the region of the display is proximate to an edge of the display, and wherein the region of the display is to accept drag and drop requests. The instructions then cause the system to share the object with at least one computing device via a network.

In yet another example in accordance with the present disclosure, a method is provided. The method comprises detecting, at a source computing device, that an object is moved and released such that at least a portion of the released object overlaps at least a portion of a region of a display of the source computing device, wherein the region of the display is registered to accept drag and drop requests. The method additionally comprises sharing, by the source computing device, the object with at least one computing device via a network.

As used herein, the term “object” should be generally understood as meaning content presented on a display. Examples of objects include, but are not limited to, images, videos, web pages, application instances, virtual desktop screen instances, folders, or other similar content. These types of content are typically displayed on computers, tablets, and/or smartphones, and pursuant to aspects of the present disclosure, may be shared with a destination device in a rapid and intuitive manner. In addition to the content types listed above (i.e., images, videos, web pages, application instances, virtual desktop screen instances, folders, or other similar content), it should be understood that the object may also represent a reference to these content types. For example, a remote desktop connection when shared with a destination device may include enough reference data to re-establish the link to a remote desktop from the destination device. Similarly, a reference such as a URL may be shared instead of an actual webpage in some examples.

As used herein, the term “proximate” should be generally understood as meaning very close or adjacent to another element. For example, a region that is “proximate” to an edge of a display may be very close to the edge (e.g., within 1-3 centimeters to the edge) or adjacent to the edge.

As used herein, the term “share” or “sharing” should be broadly understood as meaning that an object is made available for another device to retrieve or is communicated or transferred to the other device.

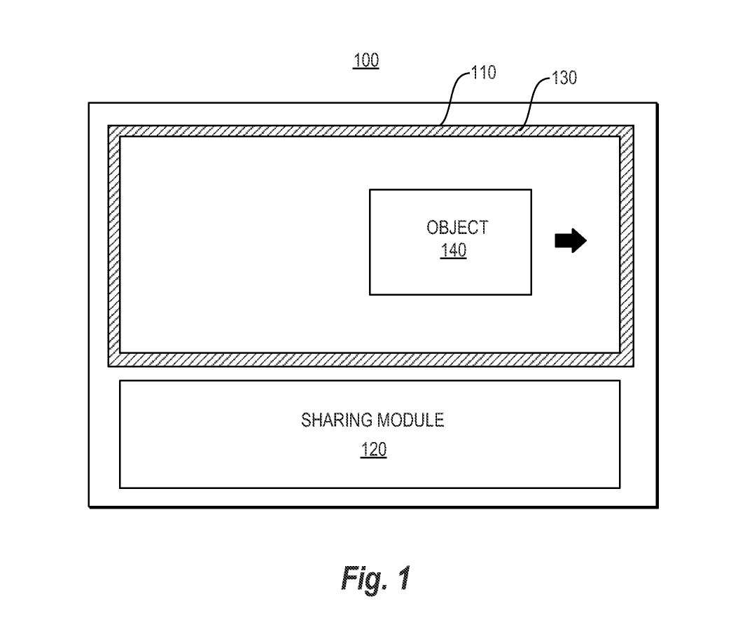

FIG. 1 depicts an example system 100 in accordance with an implementation. The system comprises a display 110, a sharing module 120, and an object 140. It should be readily apparent that the system 100 is a generalized illustration and that other elements may be added or existing elements may be removed, modified, or rearranged without departing from the scope of the present disclosure. For example, while the system 100 depicted in FIG. 1 includes only one object 140, the system 100 may actually comprise more objects 140. Moreover, while FIG. 1 only depicts one continuous region of the display 130 located proximate to all four edges of the display, in some implementations, there may be multiple separate regions of the display (e.g., a first region proximate to a left edge of the display, a second region proximate to a right edge of the display, a third region proximate to a top edge of the display, and a fourth region proximate to a bottom edge of the display) with each region providing different transferring functionality, and only one has been shown for brevity.

The system 100 may comprise any type of electrical device that includes a display 110. For example, the system 100 may comprise a personal computer, laptop, tablet, all-in-one (AiO) computer, display, retail point of sale device, scientific instrument, smartphone, television, gaming device, or another similar electronic device with a display 110. The display 110 may comprise any type of display capable of presenting objects to a user. For example, the display 110 may comprise a liquid crystal display (LCD), plasma display, light emitting diode (LED) display, organic LED (OLED) display, thin film transistor display (TFTLCD), super LCD, active matrix OLED, retina display, cathode ray tube (CRT), electroluminescent display (ELD), or another type of display capable of presenting objects 140. In some implementations, the display 110 may incorporate touch screen technology, such as resistive touchscreen technology, capacitive touch screen technology, surface acoustic wave touchscreen technology, surface capacitance touchscreen technology, projected capacitance touchscreen technology, infrared grid, touchscreen technology, infrared acrylic projection touchscreen technology, optical imaging touchscreen technology, dispersive signal touchscreen technology, or any other type of touchscreen technology which enables objects 140 on the display 110 to be controlled via touch input.

The system 100 comprises a sharing module 120. Depending on the implementation, the sharing module 120 may be implemented in hardware, software, or a combination of both. For example, the sharing module 120 may comprise instructions executable by a processing device to cause the system 100 to conduct functions discussed herein. Alternatively or in addition, the sharing module 120 may comprise a hardware equivalent such as an application specific integrated circuit (ASIC), a logic device (e.g., PLD, CPLD, FPGA. PLA. PAL, GAL, etc.), or combination thereof configured to conduct functions discussed herein.

In one example implementation, the sharing module 120 detects when an object 140 is moved and released such that at least a portion of the released object 140 overlaps at least a portion of the region of the display 130. Stated differently, the sharing module 120 detects when an object is moved with respect to the display (e.g., via mouse or touch input) and released in a manner that overlaps at least a portion of the region of the display 130. In some implementations, the object 140 may be required to be moved and released such that the part of the object currently being held (i.e., the part under the cursor, mouse, or finger) overlaps at least a portion of the region of the display 130. As shown in FIG. 1, the region of the display 130 may be a thin region proximate to an edge of the display 110 (e.g., a 5 pixel wide strip located adjacent to the edge of the display). This region of the display 130 may be registered with drag and drop functionality such that the region of the display 130 can accept drag and drop requests. When the sharing module 120 detects that an object 140 is moved and released in the region of the display 130, the sharing module 120 may consider this a drag and drop action, and cause the system 100 to share the object with a computing device over a network. In some implementations, the sharing module 120 may cause the system 100 to share the object with the computing device by placing the object in a shared network folder and sending a broadcast message informing other networked devices that the object is in the shared folder and may be retrieved if applicable to the network device(s). In other implementations, the sharing module 120 may cause the system 100 to share the object with the computing device by accessing a configuration file to determine which destination device to send the object to and what action to perform on the object at the destination device. For instance, the sharing module 120 may determine that a released object should be sent to a nearby tablet and displayed in a particular portion of the tablet upon receipt.

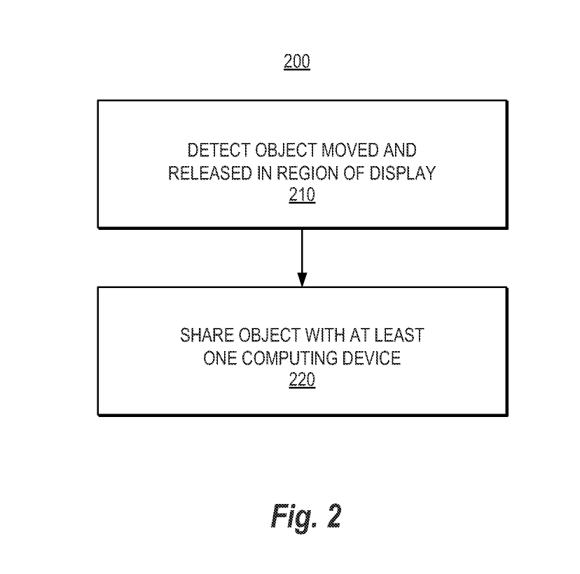

FIG. 2 depicts an example flow chart of a sharing process 200 in accordance with an implementation. This process 200 may be conducted by the previously-mentioned sharing module 120. It should be readily apparent that the processes depicted in FIGS. 2-4 represent generalized illustrations, and that other processes may be added or existing processes may be removed, modified, or rearranged without departing from the scope and spirit of the present disclosure. In addition, it should be understood that the processes depicted in FIGS. 2-4 may represent instructions stored on a processor-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components.

Furthermore, the flow charts are not intended to limit the implementation of the present disclosure, but rather the flow charts illustrate functional information that one skilled in the art could use to design/fabricate circuits, generate software, or use a combination of hardware and software to perform the illustrated processes.

The process 200 may begin at block 210, when the electronic device (e.g., a personal computer, laptop, tablet, all-in-one (AiO) computer, display, retail point of sale device, scientific instrument, smartphone, television, gaming device, etc.) and/or a module therein (e.g., the sharing module) detects that an object (e.g., images, videos, web pages, application instances, virtual desktop screen instances, folders, or other similar content) has been moved and released such that at least a portion of the released object overlaps at least a portion of a region of the display. As mentioned above, the region of the display may comprise a thin region proximate to an edge of the display (e.g., a 1 pixel wide strip located at the edge of the display). Additionally, and as mentioned above, there may be a plurality of regions on the display in some implementations (e.g., a left edge region, a right edge region, a top edge region, and a bottom edge region), and each region may be associated with a different region name, a different destination device, and/or a different action to be performed on the object. Furthermore, and as mentioned above, each region may be registered with drag and drop functionality.

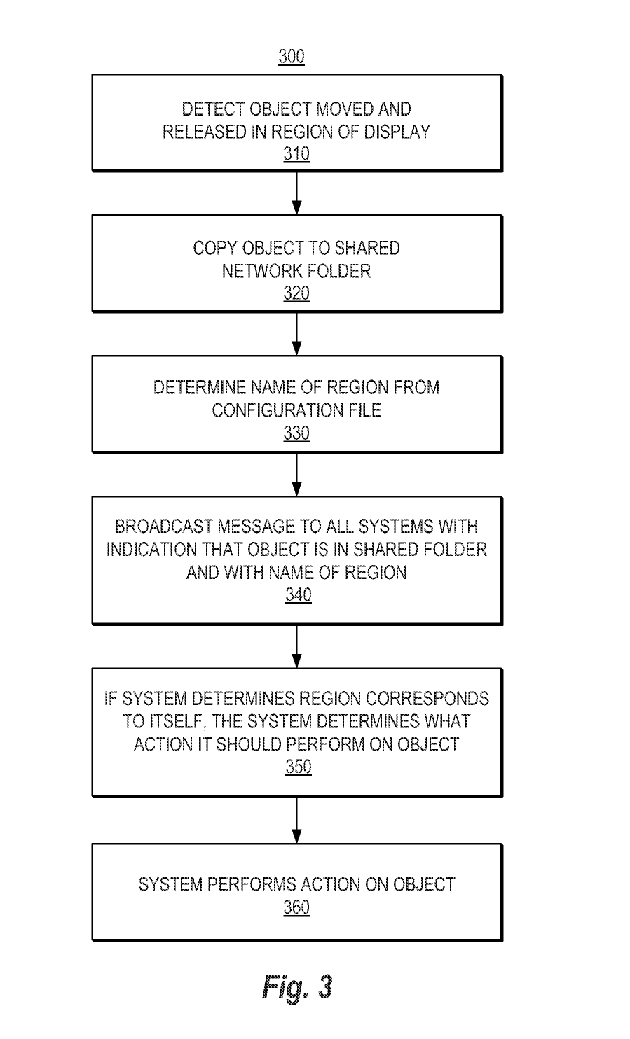

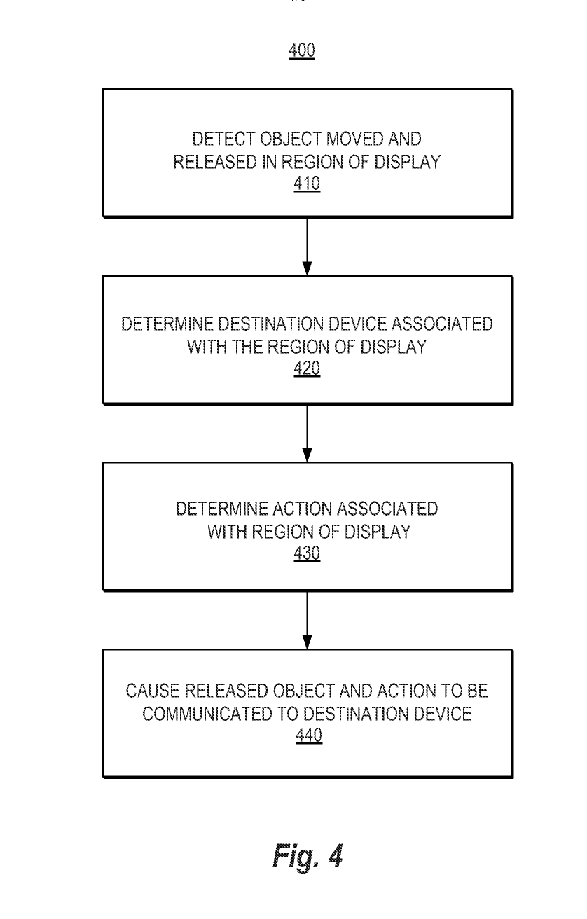

At block 220, in response to an object being dragged and released in a region of the display, the electronic device and/or module therein may share the object with at least one computing device. As mentioned above, and as described further with respect to FIG. 3, this sharing may occur by placing the object in a shared network folder and sending a broadcast message informing other networked devices that the object is in the shared folder and may be retrieved if applicable to the network device(s). Alternatively, and as described further with respect to FIG. 4, the sharing may occur by determining which destination device to send the object to, and sending the object to the destination device.

FIG. 3 depicts an example flow chart of a sharing process 300 that utilizes a shared network folder in accordance with an implementation. As mentioned above, it should be understood that the processes depicted represent generalized illustrations, and that other processes may be added or existing processes may be removed, modified, or rearranged without departing from the scope and spirit of the present disclosure.

The process 300 may begin at block 310, where the electronic device (e.g., a personal computer, laptop, tablet, all-in-one (AiO) computer, display, retail point of sale device, scientific instrument, smartphone, television, gaming device, etc.) and/or a module therein (e.g., the sharing module) detects that an object (e.g., images, videos, web pages, application instances, virtual desktop screen instances, folders, or other similar content) has been moved and released such that at least a portion of the released object overlaps at least a portion of a region of the display.

At block 320, the electronic device and/or module therein copies the object to a shared network folder. This network folder may be accessible by a plurality of other systems on the network. For example, the shared network folder may be accessible by desktops, laptops, smartphones, displays, tablets, and other computing devices that are part of the network.

At block 330, the electronic device and/or module therein determines a name for the region of the display. In one example implementation, the electronic device and/or module therein may access a configuration file and convert the mouse coordinates of the region of the display into a region name.

At block 340, the electronic device and/or module therein sends a broadcast message to all systems on the network indicating that the object is in the shared folder and includes the above-mentioned region name. In one example implementation, the electronic device and/or module therein sends the broadcast message ‘drop <region> <filename>’, with <region> indicating the region name, and <filename>indicating the name of the file that was placed in the shared network folder. It should be noted that while broadcast messages are described here, in some implementations, other types of messages such as unicast and multicast may also be utilized.

At block 350, the receiving system(s) examine the received broadcast message and determine if the identified region corresponds to itself. More specifically, the receiving system(s) may examine the message and each one individually determines if the region name corresponds to itself. If the receiving system(s) determines that the region name corresponds to itself, the receiving system(s) may examine their own respective configuration file(s) to determine what action it should perform on the shared object once obtained from the shared network folder.

At block 360, the receiving system(s) that correspond to the region name perform an action on the object. In particular, the receiving system(s) may perform actions such as loading and displaying the object, copying the object to local storage and placing an icon on the desktop, printing the object, starting or resuming playback of a music or video object, or the like.

FIG. 4 depicts an example flow chart of a sharing process 400 that determines a destination device and sends the object directly to the destination device in accordance with an implementation.

The process 400 may begin at block 410, when the electronic device (e.g., a personal computer, laptop, tablet, all-in-one (AiO) computer, display, retail point of sale device, scientific instrument, smartphone, television, gaming device, etc.) and/or a module therein (e.g., the sharing module) detects that an object (e.g., images, videos, web pages, application instances, virtual desktop screen instances, folders, or other similar content) has been moved and released such that at least a portion of the released object overlaps at least a portion of a region of the display. As mentioned above, the region of the display may comprise a thin region proximate to an edge of the display (e.g., a 1 pixel wide strip located at the edge of the display). Additionally, and as mentioned above, there may be a plurality of regions on the display in some implementations (e.g., a left edge region, a right edge region, a top edge region, and a bottom edge region), and each region may be associated with a different destination device and/or a different action to be performed on the object. Furthermore, and as mentioned above, each region may be registered with drag and drop functionality.

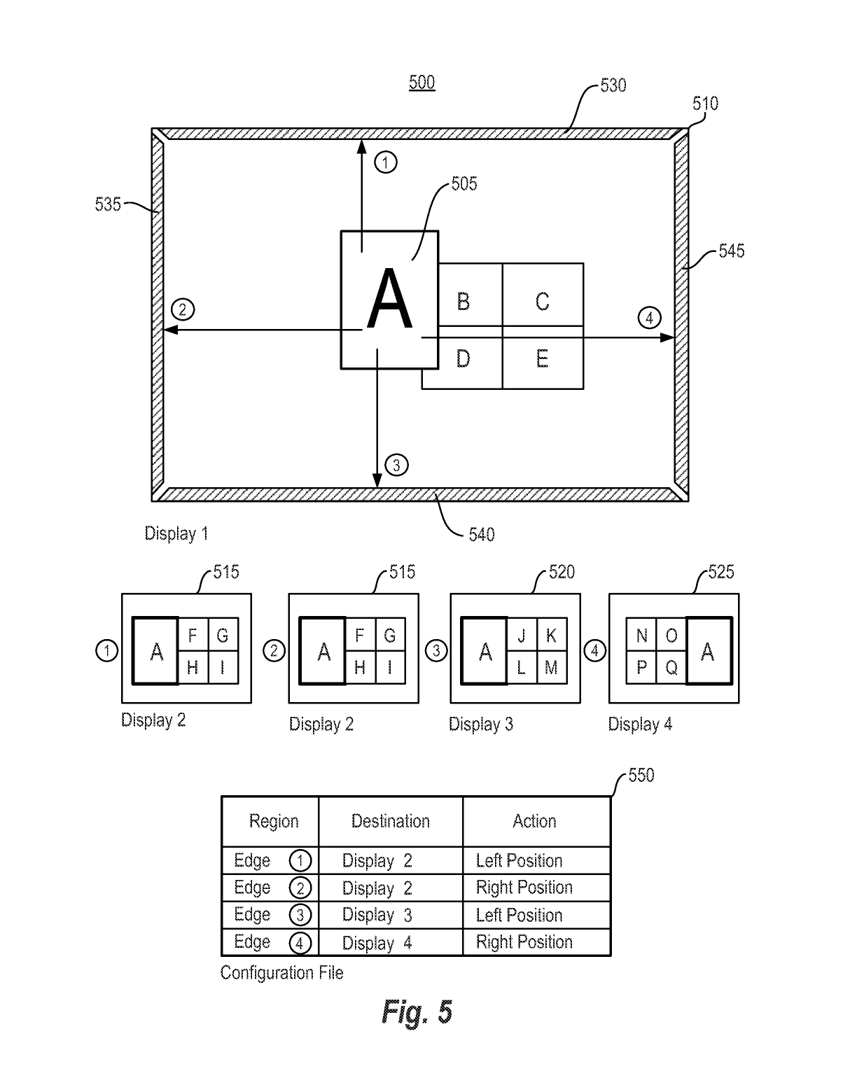

At block 420, the electronic device and/or module therein may determine a destination device associated with the region of the display. This may be accomplished by accessing a configuration file that includes a destination device for the region of the display. In some implementations, there may be a plurality of regions of the display, and each may be associated with a different destination device. For example, the left edge of the display may be associated with a tablet destination device, the right edge of the display may be associated with an AiO destination device, the top edge of the display may be associated with a laptop destination device, and the bottom edge of the display may be associated with a display destination device. Thus, when an object is moved and released in a region of the display, the device and/or module may access a configuration file (as shown in FIG. 5) and determine what destination device is associated with that region of the display.

At block 430, the electronic device and/or module therein may determine an action associated with the region of the display. An action may be, for example, saving the released object, opening the released object with a specific application, placing the released object in a specific position on the destination device, presenting the object on the destination device in the same manner as previously presented on the source electronic device, copying the object to local storage and placing an icon on the desktop, printing the object, starting or resuming playback of the object (in the case of an audio and/or video object), or the like. Similar to determining the destination device, the action may be determined by accessing the configuration file and determining what action is associated with the region of the display. Furthermore, and similar to above, there may be a plurality of regions of the display, and each may be associated with a different action. For example, the left edge of the display may be associated with placing the released object in a specific position on the destination device, and the right edge of the display may be associated with a saving the released object at the destination device. Thus, depending on which edge of the screen the object is moved and released, the object may be communicated to a specific destination device and with a specific action to perform thereon.

At block 440, the electronic device and/or module therein may cause the object and/or action to be communicated to the destination device. The object and/or action may be communicated via various communication protocols and communication mediums. For example, at least one of the following may be utilized: wired/wireless networks, local area networks (LANs), wide area network (WANs), telecommunication networks, the Internet, an Intranet, computer networks, Bluetooth networks, Ethernet LANs, and token ring LANs. Such networks may utilize mediums including, but not limited to, copper, fiber optics, coaxial, unshielded twisted pair, shielded twisted pair, heliax, radio frequency (RF), infrared (IR), and/or microwave. Furthermore, protocols such as TCP/IP, 802.11, NFC, Bluetooth, XMove, Xpra, VNC, X2X, and other similar communication protocols may be utilized to transfer the object and related data.

FIG. 5 depicts an example graphical representation 500 of object transferring in accordance with an implementation. More specifically, FIG. 5 depicts transferring an object 505 on a first display 510 to a second display 515, third display 520, and fourth display 525 in response to moving and releasing the object 505 in a first region 530, second region 535, third region 540, or fourth region 545 of the first display 510. In addition, FIG. 5 provides an example configuration file 550 for determining which destination device to transfer the object to, and which action to perform on the object at the destination device.

Beginning with the first region 530, in response to a user utilizing a mouse input, touch input, or other graphical interface input to move the object 505 and releasing the object 505 such that at least a portion of the object 505 overlaps at least a portion of the first region 530, the first display and/or a module therein may access the configuration file 550 and determine what destination device and object is associated with the first region 530. Based on the configuration file shown in FIG. 5, the first display and/or module therein determines that the destination device is the second display 515 and the action is to display the object in the left position. Consequently, the first display 310 communicates the object 505 to the second display 515, and as shown as #1 in FIG. 5, the object is display in the left position on the second display 515.

Turning now to the second region 535, in response to a user utilizing a mouse input, touch input, or other graphical interface input to move the object 505 and releasing the object 505 such that at least a portion of the object 505 overlaps at least a portion of the second region 535, the first display and/or a module therein may access the configuration file 550 and determine what destination device and object is associated with the second region 535. Based on the configuration file shown in FIG. 5, the first display and/or module therein determines that the destination device is again the second display 515 and the action is to display the object in the right position. Consequently, the first display 510 communicates the object 505 to the second display 515, and as shown as #2 in FIG. 5, the object is display in the right position on the second display 515.

Moving on to the third region 540, in response to a user utilizing a mouse input, touch input, or other graphical interface input to move the object 505 and releasing the object 505 such that at least a portion of the object 505 overlaps at least a portion of the third region 540, the first display and/or a module therein may access the configuration file 550 and determine what destination device and object is associated with the third region 540. Based on the configuration file shown in FIG. 5, the first display and/or module therein determines that the destination device is the third display 520 and the action is to display the object in the left position. Consequently, the first display 510 communicates the object 505 to the third display 520, and as shown as #3 in FIG. 5, the object is display in the left position on the third display 520.

Turning now to the fourth region 545, in response to a user utilizing a mouse input, touch input, or other graphical interface input to move the object 505 and releasing the object 505 such that at least a portion of the object 505 overlaps at least a portion of the fourth region 545, the first display and/or a module therein may access the configuration file 550 and determine what destination device and object is associated with the fourth region 545. Based on the configuration file shown in FIG. 5, the first display and/or module therein determines that the destination device is the fourth display 525 and the action is to display the object in the right position. Consequently, the first display 510 communicates the object 505 to the fourth display 525, and as shown as #4 in FIG. 5, the object is display in the right position on the fourth display 525.

It should be understood that while only displays are shown in FIG. 5, other electronic devices that include a display may be used in other implementations. For example, movement of the object 505 to different regions (530, 535, 540, and 545) on the first display 510 may cause the objects to be communicated to destination devices like personal computers, laptops, tablets, all-in-one (AiO) computers, displays, retail point of sale devices, scientific instruments, smartphones, televisions, gaming devices, or another similar electronic devices with a display. Moreover, the first display 310 may be embodied in one of these electronic devices. It should be further understood that, in some implementations, the destination device does not display the received object. Rather, the destination device may perform another action such as saving the object to a specific location or printing the object (in the case when the destination device is a printer or is associated with a printer).

Additionally, it should be understood that the regions (530, 535, 540, and 545) may be any size (e.g., 1 pixel wide, 5 pixel wide, 10 pixel wide, etc.), at any location (e.g., edge of the display, corner of the display, etc.), and any number may be included (e.g., 1 region per display, 4 regions per display, 8 regions per display, etc.).

Furthermore, while the action shown in FIG. 5 is displaying the object in a left or right position, various other actions may occur. For example, the action may be to display the object in another position (e.g., top, bottom, bottom left corner, bottom right corner, center, etc.), display the object another manner (e.g., overlapping other displayed subject matter, etc.), display the object on a secondary display of the receiving device, display the object with another setting (e.g., transparent, semi-transparent, with or without audio, enlarged, shrunk, etc.), open the object with the same or a different application, save the object to a location (e.g., a particular folder, the desktop, etc.), or the like. Moreover, the action may be to display the object on the destination device in the same manner as previously displayed at the source device. So for example, if the object is a video that is being displayed in the upper left hand quadrant of the source device with volume muted, the action may similarly be to display the video in the upper left hand quadrant of the destination device with the volume muted. Furthermore, the positions on the destination display aren't limited to left and right, nor to any preset list of positions. The positions may be defined according to a configuration file or a layout (stored either at the source or destination device), and objects may either replace the object already present in a position (i.e., a swap), or can be placed in the proximity of an object already on the display (left-of, above-of, right-of, below-of), or can be placed into a defined position which is currently empty, or can be restored to a location that was previously vacated (restore), or can be sized to fill the full screen (zoom) in combination with any of the preceding placement types.

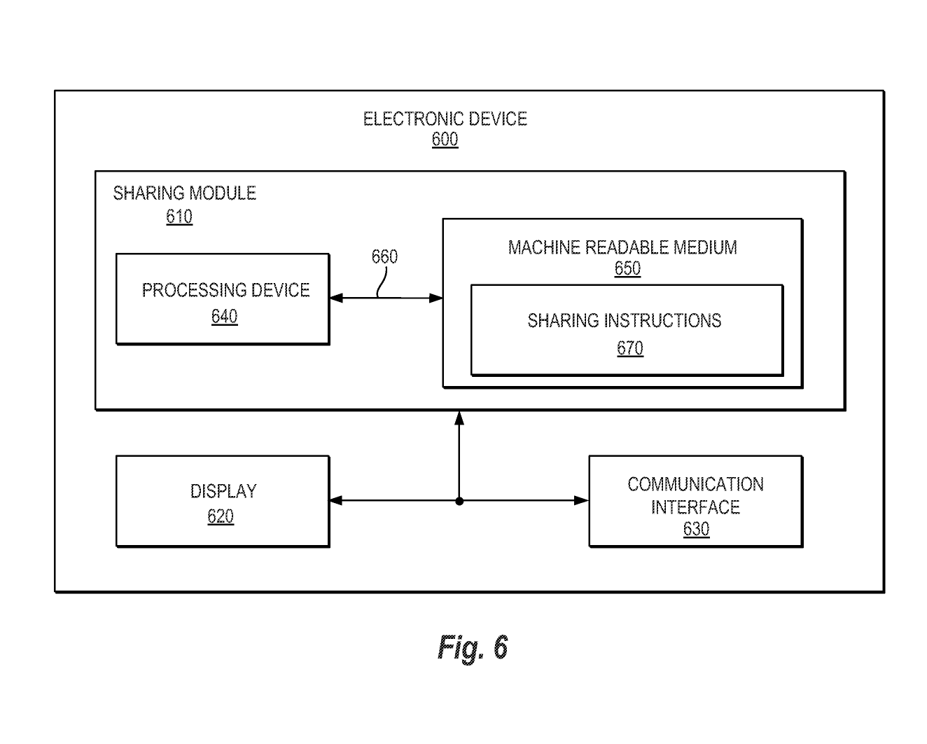

FIG. 6 depicts an example electronic device 600 in accordance with an implementation. The electronic device 600 may be, for example, a personal computer, laptop, tablet, all-in-one (AiO) computer, display, retail point of sale device, scientific instrument, smartphone, television, gaming device, printer, or another similar electronic device. The electronic device 600 comprises a sharing module 610, a display 620, and a communication interface 630.

The sharing module 610 comprises a processing device 640 and a non-transitory machine-readable medium 650 communicatively coupled via a bus 660. The non-transitory machine-readable medium 450 may correspond to any typical storage device that stores instructions, such as programming code or the like. For example, the non-transitory machine-readable medium 650 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that may be executed by the processing device 640. In this case, the non-transitory machine-readable medium 650 may be a portable medium such as a CD, DVD, or flash drive or a memory maintained by a server from which the installation package can be downloaded and installed. In another implementation, the instructions may be part of an application or application already installed.

The processing device 640 may be at least one of a processor, central processing unit (CPU), a semiconductor-based microprocessor, or the like. It may retrieve and execute instructions such as the sharing instructions 670 to cause the electronic device 600 to operate in accordance with the foregoing description. In one example implementation, the processing device 640 may access the machine-readable medium 650 via the bus 660 and execute the sharing instructions 670 to cause the electronic device 600 to detect that an object is moved and released such that a portion of the released object overlaps a region of a display 620, wherein the region of the display is proximate to an edge of the display. The sharing instructions 670 may further cause the electronic device 600 to share the object with another device on the network via the communication interface 630. The communication interface 630 may comprise, for example, transmitters, receivers, transceivers, antennas, ports, PHYs, and/or other components not shown in FIG. 6.

The foregoing describes a novel and previously unforeseen approach to share objects in a rapid and intuitive manner. As discussed, in some implementations, the sharing module may dictate the behavior of objects once they are dragged and released near the edge of a display. The object may be, for example, images, video, web pages, applications, screen instances from other computers, or other forms of content. The sharing module may detect the movement, and, based thereon, share the object with another device. Among other things, this new approach may allow display interactivity with large display walls, workstations, and personal tablets to be very intuitive and effective when used for presentations or when doing collaborations or any activity involving the movement of objects across displays. While the above disclosure has been shown and described with reference to the foregoing examples, it should be understood that other forms, details, and implementations may be made without departing from the spirit and scope of the disclosure that is defined in the following claims.

What is claimed is:

1. A system comprising:
a display; and
a sharing module, wherein the sharing module is to
detect that a first object is moved and released such that at least a portion of the released first object overlaps at least a portion of a first region of the display, wherein the first region of the display is proximate to a first edge of the display; and
cause the system to share the first object with at least one computing device via a network.

2. The system of claim 1, wherein the sharing module is to cause the system to share the first object with the at least one computing device via the network by including the first object in a shared network folder, and sending a message to the at least one computing device indicating that the first object is in the shared network folder.

3. The system of claim 2, wherein the sharing module is further to:
determine an identifier associated with the first region of the display by accessing a configuration file; and
include the identifier associated with the first region of the display in the message.

4. The system of claim 2, wherein the message is a broadcast message.

5. The system of claim 1, wherein the first object comprises at least one of video, audio, and text.

6. The system of claim 1, wherein the first object comprises at least one of a webpage, a media player, an application, a file, and a remote desktop instance.

7. The system of claim 1, wherein the first region of the display is to accept drag and drop requests.

8. The system of claim 1, wherein the sharing module is to cause the system to share the first object with the at least one computing device via the network by determining that the at least one computing device is associated with the first region of the display, and causing the first object to be communicated to the at least one computing device.

9. The system of claim 8, wherein the sharing module is further to:
determine an action associated with the first region of the display; and
cause the action to be communicated to the at least one computing device.

10. The system of claim 9, wherein the action comprises at least one of saving the first object, opening the first object with a specific application, opening the first object with a specific setting, and placing the first object in a specific position on the at least one computing device.

11. The system of claim 1, wherein the sharing module is further to:
detect that a second object is moved and released such that at least a portion of the released second object overlaps at least a portion of a second region of the display, wherein the second region of the display is proximate to a second edge of the display; and
cause the system to share the second object with at least one computing device via the network.

12. A non-transitory machine readable medium comprising instructions which, when executed, cause a system to:
detect that an object is moved and released such that at least a portion of the released object overlaps at least a portion of a region of a display, wherein the region of the display is proximate to an edge of the display; and wherein the region of the display is to accept drag and drop requests; and
cause the system to share the object with at least one computing device via a network.

13. The non-transitory machine readable medium of claim 12, wherein the instructions, when executed, cause the system to share the object with the at least one computing device via the network by including the object in a shared network folder, and sending a message to the at least one computing device indicating that the first object is in the shared network folder.

14. The non-transitory machine readable medium of claim 12, wherein the instructions, when executed, cause the system to share the object with the at least one computing device via the network by determining that the at least one computing device is associated with the first region of the display, and causing the object to be communicated to the at least one computing device.

15. The non-transitory machine readable medium of claim 12, wherein the object comprises at least one of a webpage, a media player, an application, a file, and a remote desktop instance.

16. A method, comprising:
detecting, at a source computing device, that an object is moved and released such that at least a portion of the released object overlaps at least a portion of a region of a display of the source computing device, wherein the region of the display is registered to accept drag and drop requests; and
sharing, by the source computing device, the object with at least one computing device via a network.

17. The method of claim 16, wherein the region of the display is proximate to an edge of the display.

18. The method of claim 16, further comprising sharing the object with the at least one computing device by placing the object in a shared network folder, and sending a message to the at least one computing device indicating that the object is in the shared network folder.

19. The method of claim 16, further comprising sharing the object with the at least one computing device by determining that the at least one computing device is associated with the first region of the display, and causing the object to be communicated to the at least one computing device.

20. The method of claim 16, wherein the object comprises at least one of video, audio, and text.
